(19) United States
(12) Patent Application Publication
(10) Pub. No.: US 2007/0185970 A1
(43) Pub. Date: Aug. 9, 2007

(54) Method, system, and computer program product for providing messaging services

(75) Inventors: Robert T. Arenburg, Round Rock, TX (US); Franck Barillaud, Austin, TX (US); Bradford L. Cobb, Cedar Park, TX (US); Shivnath Dutta, Round Rock, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/350,065

(22) Filed: Feb. 8, 2006

(51) Int. Cl. G06F 15/16

(52) U.S. Cl. 709/217

(57) ABSTRACT

A method, system, and computer program product for implementing messaging services is provided. The method includes receiving a request to delete a message that includes an attachment from a computer system. In response to the request, a user of the computer system is provided with options to save the attachment and to delete the attachment along with the message. If the user selects the delete option, the message is sent to a messaging system trash folder and the attachment is sent to an operating system trash folder. If the user selects the option to save the attachment, the message is separated from the attachment and the user is prompted to select an operating system storage location for saving the attachment. In response to receiving the selected operating system storage location, a copy of the attachment is stored in the selected location and the message is sent to the messaging system trash folder.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic communications, and more particularly to a method, system, and computer program product for implementing messaging services.

2. Description of Background

Various messaging applications are widely utilized for implementing electronic communications. Messaging applications, such as an email client, enable individuals to send and receive file attachments along with the email messages. Typically, when an individual seeks to delete a message (e.g., from an email inbox), the individual selects the message to be removed, followed by a “delete” option. However, if the message contains an attachment, the attachment will also be removed from the message folder as part of the “delete” process. There may be instances, however, where the individual does not wish to delete the attachment along with the message.

What is needed, therefore, is a way to provide a user of a messaging application the capability to save message attachments during the process of deleting a message with minimal input on the part of the user.

### SUMMARY OF THE INVENTION

The shortcomings of the prior art are overcome and additional advantages are provided through the provision of a method for implementing messaging services. The method includes receiving a request to delete a message from a computer system, the message including an attachment. In response to receiving the request, the method includes providing a user of the computer system with an option to save the attachment and an option to delete the attachment along with the message. If the user selects the option to delete the attachment, the method includes sending the message to a messaging system trash folder and sending the attachment to an operating system trash folder. If the user selects the option to save the attachment, the method includes separating the message from the attachment and prompting the user to select an operating system storage location in which to save the attachment. In response to receiving the selected storage location, the method includes saving a copy of the attachment in the selected operating system storage location and sending the message to the messaging system trash folder.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which enables a user of a messaging application to specify, during a process of deletion, whether or not to save an attachment associated with a message that has been selected for deletion and, if the user desires to save the attachment, the solution enables the user to specify a particular folder or location in storage in which to save the attachment.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting a system upon which the messaging services may be implemented in exemplary embodiments;

FIG. 2 illustrates a flow diagram describing a process for implementing the messaging services in exemplary embodiments;

FIG. 3 depicts a user interface screen provided by the messaging services for deleting a message in exemplary embodiments; and

FIG. 4 depicts a user interface screen provided by the messaging services for deleting an attachment in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, a method, system, and computer program product for implementing messaging services is provided. The messaging services enable a user of a messaging application to save message attachments during the process of deleting a message with minimal input or intervention on the part of the user.

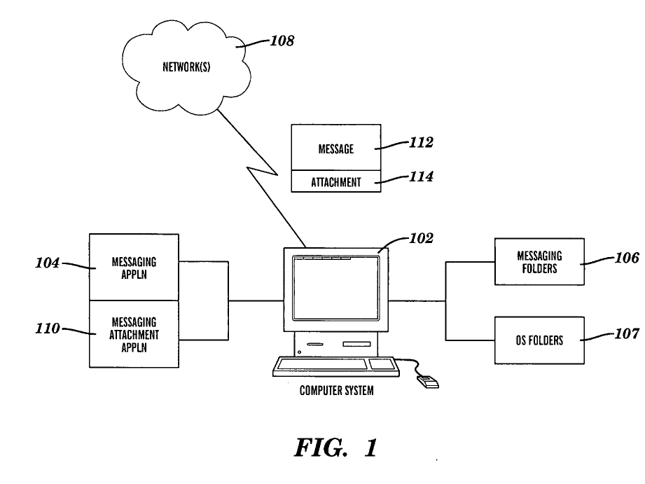

Turning now to FIG. 1, a system upon which the messaging services may be implemented in an exemplary embodiment will now be described. The system of FIG. 1 includes a computer system 102 executing one or more applications (e.g., word processor, web browser, etc.). Also executing on computer system 102 is a messaging application 104 (e.g., an email client). Computer system 102 may be a general-purpose computer (e.g., desktop, laptop, etc.) that includes a processor, an operating system executing on the processor, memory, input/output controls, network connectivity, and other suitable features. Computer system 102 may be a wireless or wireline device. Further, computer device 102 may be a stand-alone device or may be a client system operating in a local area network (LAN) or other distributed network system. In addition, various types of devices may be employed in implementing the messaging services (e.g., a personal digital assistant, cellular telephone, pager, etc.).

As indicated above, the computer system 102 includes internal memory for storing data, files, documents, images, etc. In exemplary embodiments, the memory stores messaging folders 106 provided by the messaging application 104. Messaging folders 106 may include an inbox, outbox, trash folder, draft folder, etc. Messaging folders 106 are managed by messaging application 104 and/or messaging attachment application 110. The internal memory also includes one or more operating system folders 107 for storing files (e.g., C drive folders, trash bin folders, recycle bin folders, etc., which are managed by an operating system of the computer system). Attachments selected for deletion are stored in operating system folders 107 as will be described further herein.

Computer system 102 is communicatively coupled to one or more networks (e.g., networks 108). Networks 108, in turn, may include one or more messaging servers (e.g., email servers—not shown) that receive and route messages among various network entities, such as computer system 102. For example, messaging servers used in processing email messages include SMTP, POP3, and IMAP. Messages, as used herein, refer to electronic communications such as emails, and may include text, images, video, audio, multi-media, etc.

Messaging attachment application 110 is also executing on computer system 102. Messaging attachment application 110 facilitates the messaging services described herein. Messaging attachment application 110 may be a “plug-in” application or application programming interface (API) for a general-purpose messaging system, such as messaging application 104. Alternatively, messaging attachment application 110 and messaging application 104 may comprise a single application. As shown in the system of FIG. 1, messaging attachment application 110 and messaging application 104 are two separate applications that communicate with one another as described herein.

A sender of an email message utilizes messaging application 104 to compose the message, which typically includes a recipient name and address, a subject line, and a body of text. The messaging application 104 enables the sender to include an attachment by, e.g., selecting an icon provided on the messaging application toolbar. When the message and attachment bundle is sent out by the messaging application, the attachment is encoded and combined with the message before being transmitted over a network. A receiving server (e.g., POP3 or IMAP) separates the attachment from the message body and decodes the attachment. The attachment may be stored in a separate holding location from the message body on the network. However, the attachment and the message are treated as a single file by the messaging application 104 for purposes of storing, accessing, and disposing of the attachment.

Also shown in the system of FIG. 1 is a message 112, which includes an attachment 114. Message 112 may be a text file, such as an email that is transmitted from network(s) 108 to computer system 102. Message 112 and attachment 114 may comprise any type of communication, such as text, data, files, images, video, audio, etc.

As indicated above, any type of network-enabled processing device that is capable of engaging in messaging transactions may be employed by the messaging services (e.g., personal digital assistant, cellular telephone, pager, LAN server, etc.). Thus, the computer desktop device 102 depicted in FIG. 1 is provided for illustrative purposes and is not to be construed as limiting in scope.

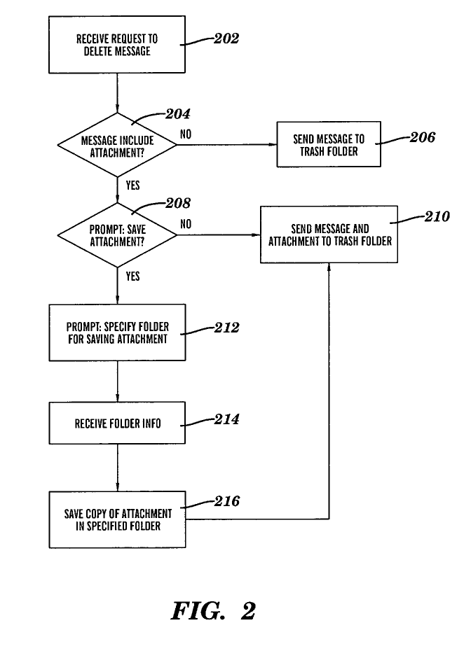

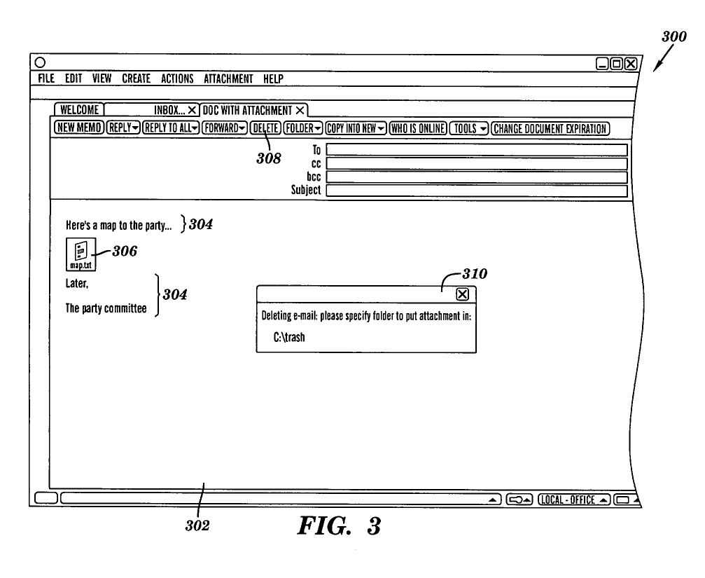

Turning now to FIG. 2, a process for implementing the messaging services in accordance with exemplary embodiments will now be described. As indicated above, the messaging services may be employed for a variety of types of applications. For purposes of illustration, the messaging application 104 utilized and described with respect to FIGS. 2 and 3 is an email application, (e.g., IBM's® Lotus Notes).

At step 202, the messaging application 104 receives a request to delete a message (e.g., email message 112) from a user of computer system 102. The request may be implemented by selecting an option provided by the messaging application 104 and/or the messaging attachment application 110. This option is shown in a user interface screen 300 depicted in FIG. 3. The user interface screen 300 illustrates a sample messaging window including a toolbar with various options available to the user (e.g., New Memo, Reply, Reply To All, Forward, Delete, Folder, Copy into New, Tools, etc.). Also shown in the user interface screen 300 is a message window 302, which displays a message body (message content) 304 and attachment 306. As illustrated in the user interface screen 300 of FIG. 3, the user has received and opened an incoming email message that includes attachment 306. By selecting the option “Delete” 308, the messaging attachment application 110 is notified that the user desires to delete the message.

At step 204, the messaging attachment application 110 identifies the message to be deleted and checks to see if the message includes an attachment (e.g., 306). If not, the messaging attachment application 104 sends the message to a trash folder (i.e., one of messaging folders 106) at step 206.

If, however, the message includes an attachment, the user is given an opportunity to save the attachment (e.g., 306). This may be implemented by prompting the user e.g., via a display query, such as “Do You Want to Save the Attached File?” (not shown) in the message window 302 at step 208. If the user declines to save the attachment 306 in response to the prompt, the messaging attachment application 110 sends the message 304 and the attachment 306 to the trash folders (e.g., folders 106 and 107 respectively) at step 210.

If the user desires to save the attachment 306 in response to the prompt, the messaging attachment application 110 separates the attachment 306 from the message 304 and queries the user to specify a location (e.g., one of folders 107) for storing the attachment at step 212, a sample of which is shown in subwindow 310 of FIG. 3. Upon receiving the user's selection at step 214, the messaging attachment application 110 sends a copy of the attachment 306 to the selected operating system storage location (e.g., folders 107) at step 216. The storage location may be internal memory of computer system 102 or may be a remote storage location. The process proceeds to step 210, whereby the message without the attachment is sent to the messaging trash folder (e.g., folder 106).

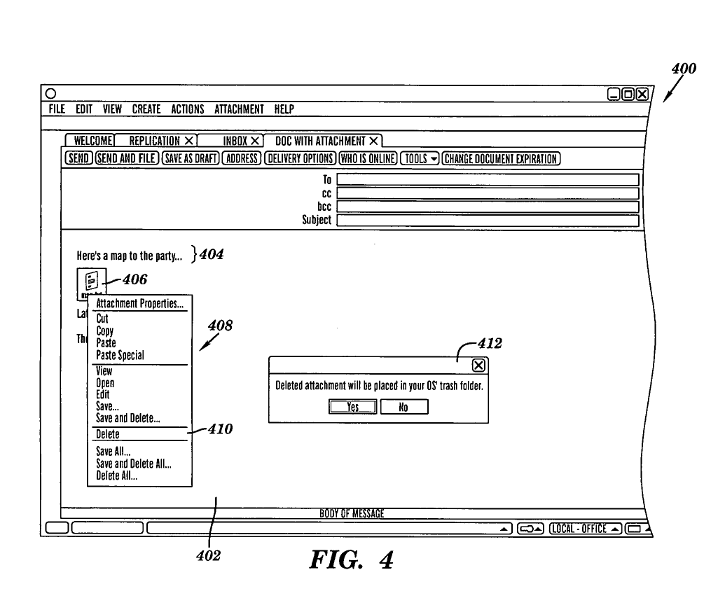

In alternative exemplary embodiments, a user may choose to directly delete an attachment via the messaging services. As shown in a sample user interface screen 400 of FIG. 4, a sample message window 402 includes a message body 404 and attachment 406. The user may ‘right click’ on the attachment 406, whereby the messaging services provides a subwindow 408, which in turn, includes a “Delete” option 410. The user selects the “Delete” option 410 and a subwindow 412 is presented to the user. The subwindow 412 may provide information regarding the destination of the attachment as a result of the deletion process. As shown in subwindow 412, for example, a message “Deleted attachment will be placed in your OS' trash folder” is presented. Selecting the “Yes” option causes the attachment to be moved to the OS' trash folder (e.g., trash folder of OS folders 107).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing messaging services, comprising:
receiving a request to delete a message from a computer system, the message including an attachment;
responsive to receiving the request, providing a user of the computer system with an option to save the attachment and an option to delete the attachment along with the message;
if the user selects the option to delete the attachment, sending the message to a messaging system trash folder and sending the attachment to an operating system trash folder; and
if the user selects the option to save the attachment:
separating the message from the attachment;
prompting the user to select an operating system storage location in which to save the attachment;
in response to receiving the operating system storage location from the user, saving a copy of the attachment in the selected operating system storage location; and
sending the message to the messaging system trash folder.

2. The method of claim 1, wherein the message is an email message.

3. The method of claim 1, wherein the attachment comprises at least one of:
text;
data;
file;
image;
video; and
audio.

4. The method of claim 1, wherein the option to save the attachment and the option to delete the attachment are presented via a user interface of a messaging attachment application.

5. The method of claim 1, wherein the computer system is at least one of a:
desktop computer;
local area network computer;
cellular telephone;
personal digital assistant; and
pager.

6. A computer system for implementing messaging services, the computer system communicatively coupled to a network, the computer system comprising:
a processor implementing an operating system and a messaging application;
messaging application folders housed in the computer system and storing at least one message that includes an attachment, the messaging application folders comprising a messaging system trash folder;
operating system folders housed in the computer system including an operating system trash folder; and
a messaging attachment application executing on the processor, the messaging attachment application in communication with the messaging application, the messaging attachment application performing:
receiving a request to delete the message from the computer system;
responsive to receiving the request, providing a user of the computer system with an option to save the attachment and an option to delete the attachment along with the message;
if the user selects the option to delete the attachment, sending the message to the messaging system trash folder and sending the attachment to the operating system trash folder; and
if the user selects the option to save the attachment:
separating the message from the attachment;
prompting the user to select an operating system storage location in which to save the attachment; and
in response to receiving the operating system storage location from the user, saving a copy of the attachment in the selected operating system storage location;
sending the message to the messaging system trash folder.

7. The computer system of claim 6, wherein the message is an email message.

8. The computer system of claim 6, wherein the attachment comprises at least one of:
text;
data;
file;
image;
video; and
audio.

9. The computer system of claim 6, wherein the option to save the attachment and the option to delete the attachment are presented via a user interface of a messaging attachment application.

10. The computer system of claim 6, wherein the computer system is at least one of a:
desktop computer;
local area network computer;
cellular telephone;
personal digital assistant; and
pager.

11. A computer program product for implementing messaging services, the computer program product including instructions for implementing a method, comprising:
receiving a request to delete a message from a computer system, the message including an attachment;
responsive to receiving the request, providing a user of the computer system with an option to save the attachment and an option to delete the attachment along with the message;
if the user selects the option to delete the attachment, sending the message to a messaging system trash folder and sending the attachment to an operating system trash folder; and
if the user selects the option to save the attachment:
separating the message from the attachment;
prompting the user to select an operating system storage location in which to save the attachment;
in response to receiving the operating system storage location from the user, saving a copy of the attachment to the selected operating system storage location; and
sending the message to the messaging system trash folder.

12. The computer program product of claim 11, wherein the message is an email message.

13. The computer program product of claim 11, wherein the attachment comprises at least one of:
text;
data;
file;
image;
video; and
audio.

14. The computer program product of claim 11, wherein the option to save the attachment and the option to delete the attachment are presented via a user interface of a messaging attachment application.

15. The computer program product of claim 11, wherein the computer system is at least one of a:
desktop computer;
local area network computer;
cellular telephone;
personal digital assistant; and
pager.
